(19) United States
(12) Patent Application Publication
(10) Pub. No.: US 2026/0321140 A1
(43) Pub. Date: Oct. 15, 2026

(54) SYSTEMS, METHODS, AND MEDIA FOR EMERGENCY MANAGEMENT AND SUPERVISION OF HIGHWAY PATCHY FOG BASED ON INTERNET OF THINGS LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Siwei ZENG, Chengdu (CN); Rui RU, Chengdu (CN)

(73) Assignee: CHENGDU QINCHUAN IOT TECHNOLOGY CO., LTD., Chengdu (CN)

(21) Appl. No.: 19/643,919

(22) Filed: Apr. 10, 2026

(30) Foreign Application Priority Data
Feb. 24, 2026 (CN) 202610221069.X

(51) Int. Cl. G08G 1/16; G01W 1/10; G08G 1/01

(52) U.S. Cl. CPC G08G 1/164; G01W 1/10; G08G 1/0116

(57) ABSTRACT

Provided are a system, a method, and a medium for emergency management and supervision of highway patchy fog based on an Internet of Things (IoT) large model, the system comprising an emergency management and supervision platform, wherein the emergency management and supervision platform is configured to: predict patchy fog prediction information of a road section under monitoring at a future time point based on micrometeorological data and geographical data of the road section under monitoring in a preset time period, wherein the micrometeorological data is collected by a monitoring point arranged in the road section under monitoring; generate an emergency instruction based on the patchy fog prediction information at the future time point and predicted traffic information at the future time point; and control activation and deactivation of an intelligent road stud and a laser lane system based on the emergency instruction.

### CROSS-REFERENCE TO RELATED APPLICATIONS

This application claims priority to the Chinese Patent Application No. 202610221069.X, filed on Feb. 24, 2026, the contents of which are hereby incorporated by reference.

### TECHNICAL FIELD

The present disclosure generally relates to a field of highway patchy fog management and supervision, and in particular to a method, system, and medium for emergency management and supervision of highway patchy fog based on an Internet of Things (IoT) large model.

### BACKGROUND

Patchy fog refers to a more “dense” fog with lower visibility that appears within a local range of tens to hundreds of meters in a large fog, influenced by the microclimate environment of a local area. Visibility is good outside the patchy fog, while the interior of the patchy fog is hazy. Furthermore, the patchy fog has strong regional characteristics and is difficult to predict and forecast. Especially on highways, the patchy fog may cause sudden changes in visibility, posing significant hazards to highway traffic safety and easily leading to major traffic accidents. Therefore, it is necessary to monitor the highway patchy fog and provide a system, method, and medium for emergency management and supervision of highway patchy fog based on an IoT large model. This system may utilize micrometeorological data, geographical data, and other information collected by sensors deployed along the roads to predict patchy fog conditions at future time points. It also generates emergency instructions to control the activation and deactivation of intelligent road studs and laser lane systems.

### SUMMARY

One or more embodiments of the present disclosure provide a system for emergency management and supervision of highway patchy fog based on an IoT large model including an emergency management and supervision platform, wherein the emergency management and supervision platform is configured to execute a method for emergency management and supervision of highway patchy fog based on an IoT large model.

One or more embodiments of the present disclosure provide a method for emergency management and supervision of highway patchy fog based on an IoT large model, the method being performed by an emergency management and supervision platform for emergency management and supervision of highway patchy fog based on the IoT large model, the method including: predicting patchy fog prediction information of a road section under monitoring at a future time point based on micrometeorological data and geographical data of the road section under monitoring in a preset time period, wherein the micrometeorological data is collected by a monitoring point arranged on the road section under monitoring; generating an emergency instruction based on the patchy fog prediction information at the future time point and predicted traffic information at the future time point; and controlling activation and deactivation of an intelligent road stud and a laser lane system based on the emergency instruction.

One or more embodiments of the present disclosure provide a non-transitory computer-readable storage medium, wherein the storage medium stores computer instructions, and when a computer reads the computer instructions in the storage medium, the computer executes the method for emergency management and supervision of highway patchy fog based on an IoT large model described above.

### BRIEF DESCRIPTION OF THE DRAWINGS

The present disclosure is further described in an exemplary manner by way of embodiments. These embodiments are described in detail with reference to the accompanying drawings. These embodiments are not restrictive. In these embodiments, the same reference numerals denote the same structures.

FIG. 1 is a schematic diagram illustrating an exemplary system for emergency management and supervision of highway patchy fog based on an IoT large model according to some embodiments of the present disclosure;

FIG. 2 is a flowchart illustrating an exemplary method for emergency management and supervision of highway patchy fog based on an IoT large model according to some embodiments of the present disclosure;

FIG. 3 is a schematic diagram illustrating an exemplary patchy fog prediction model according to some embodiments of the present disclosure;

FIG. 4 is a schematic diagram illustrating an exemplary generation of an emergency instruction according to some embodiments of the present disclosure;

FIG. 5 is a schematic diagram illustrating an exemplary generation of a first-level emergency instruction and a second-level emergency instruction according to some embodiments of the present disclosure.

### DETAILED DESCRIPTION

To more clearly illustrate the technical solutions of the embodiments of the present disclosure, the drawings used in the description of the embodiments are briefly introduced below. Obviously, the drawings in the following description are merely some examples or embodiments of the present disclosure. For a person of ordinary skill in the art, the present disclosure may be applied to other similar scenarios based on these drawings without creative efforts. Unless obviously obtained from the context or the context illustrates otherwise, the same numeral in the drawings refers to the same structure or operation.

It should be understood that the terms “system”, “device”, “unit”, and/or “module” used herein are methods for distinguishing different components, elements, parts, sections, or assemblies at different levels. However, the terms may be replaced by other expressions if the other expressions achieve the same purpose.

As shown in the present disclosure and the claims, unless the context clearly indicates an exception, the terms “a”, “an”, “one”, and/or “the” are not intended to refer specifically to a singular form and may also include a plural form. Generally, the terms “include” and “contain” only indicate that clearly identified steps and elements are included, and these steps and elements do not constitute an exclusive list. A method or device may also include other steps or elements.

The present disclosure uses flowcharts to illustrate operations performed by the system according to the embodiments of the present disclosure. It should be understood that the preceding or following operations are not necessarily performed precisely in order. On the contrary, the steps may be processed in reverse order or simultaneously. At the same time, other operations may be added to these processes, or one or more steps may be removed from these processes.

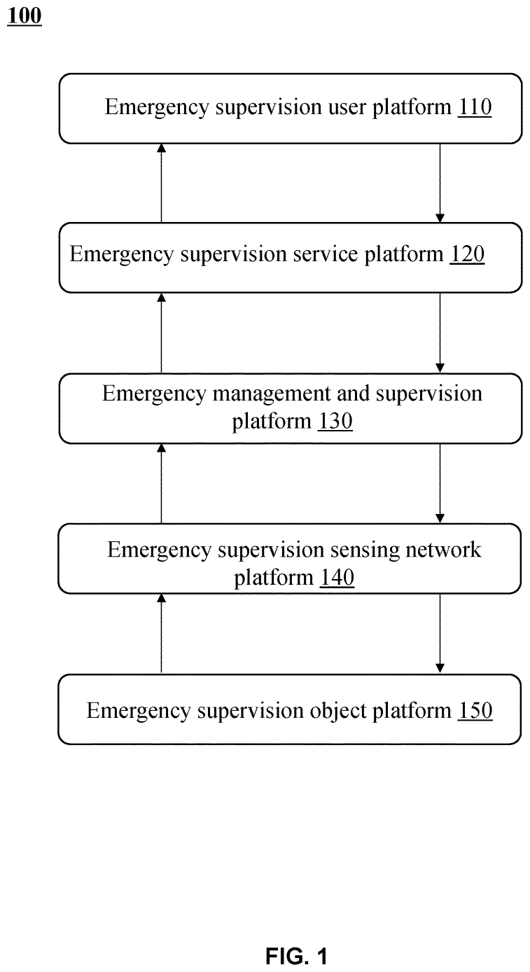

FIG. 1 is a schematic diagram illustrating an exemplary system for emergency management and supervision of highway patchy fog based on an IoT large model according to some embodiments of the present disclosure. It should be noted that the following embodiments are only used to explain the present disclosure and do not constitute a limitation on the present disclosure.

In some embodiments, a large model or an IoT large model refers to an IoT model architecture capable of achieving efficient operation of a large amount of data in a system. In some embodiments, an artificial intelligence (AI) model may be applied to the IoT model architecture to assist in perception and processing of data.

In some embodiments, as shown in FIG. 1, the system 100 for emergency management and supervision of highway patchy fog based on an IoT large model may include an emergency supervision user platform 110, an emergency supervision service platform 120, an emergency management and supervision platform 130, an emergency supervision sensing network platform 140, and an emergency supervision object platform 150.

In some embodiments, one or more platforms in the system 100 for emergency management and supervision of highway patchy fog based on an IoT large model may exchange information and/or data through a network. In some embodiments, the network may be any one or more of a wired network or a wireless network.

The emergency supervision user platform 110 refers to a platform for obtaining operation information of the entire IoT system and issuing supervision requirements. Supervision users may be personnel from safety management departments, citizens, etc. In some embodiments, the emergency supervision user platform may include at least one personnel interaction device. For example, the personnel interaction device may include a mobile phone, a computer, or the like.

The emergency supervision service platform 120 refers to a platform for receiving and transmitting data and/or information. In some embodiments, the emergency supervision service platform 120 may be configured as a server or a processor. In some embodiments, the emergency supervision service platform 120 may perform bidirectional data interaction with the emergency supervision user platform 110 and the emergency management and supervision platform 130.

The emergency management and supervision platform 130 is a comprehensive management platform for managing, coordinating, and coordinating connections and collaborations among a plurality of platforms. The emergency management and supervision platform may be configured as a server or a processor. In some embodiments, the emergency management and supervision platform 130 is communicatively connected to the emergency supervision object platform 150 through the emergency supervision sensing network platform 140.

In some embodiments, the emergency management and supervision platform is configured to: predict patchy fog prediction information of a road section under monitoring at a future time point based on micrometeorological data and geographical data of the road section under monitoring in a preset time period, wherein the micrometeorological data is collected by a monitoring point arranged on the road section under monitoring; generate an emergency instruction based on the patchy fog prediction information at the future time point and predicted traffic information at the future time point; and control activation and deactivation of an intelligent road stud and a laser lane system based on the emergency instruction.

The emergency supervision sensing network platform 140 is used for comprehensively managing sensing information and is a communication transmission platform for achieving bidirectional data interaction between the emergency management and supervision platform 130 and the emergency supervision object platform 150. In some embodiments, the emergency supervision sensing network platform 140 may be configured as a communication network, a gateway, or other devices. The emergency supervision sensing network platform 140 is responsible for uploading real-time sensing data collected by the emergency supervision object platform to the emergency management and supervision platform 130, and delivering regulation instructions generated at the emergency management and supervision platform 130 to a corresponding emergency supervision object platform 150 for execution.

The emergency supervision object platform 150 is a platform for generating supervision information and executing control information. In some embodiments, the emergency supervision object platform 150 may include various monitoring, sensing, and interaction devices, e.g., a laser radar road section scanning array, a sensor, an environmental DNA (eDNA) automatic sampler, an intelligent road stud, a laser lane system, or the like.

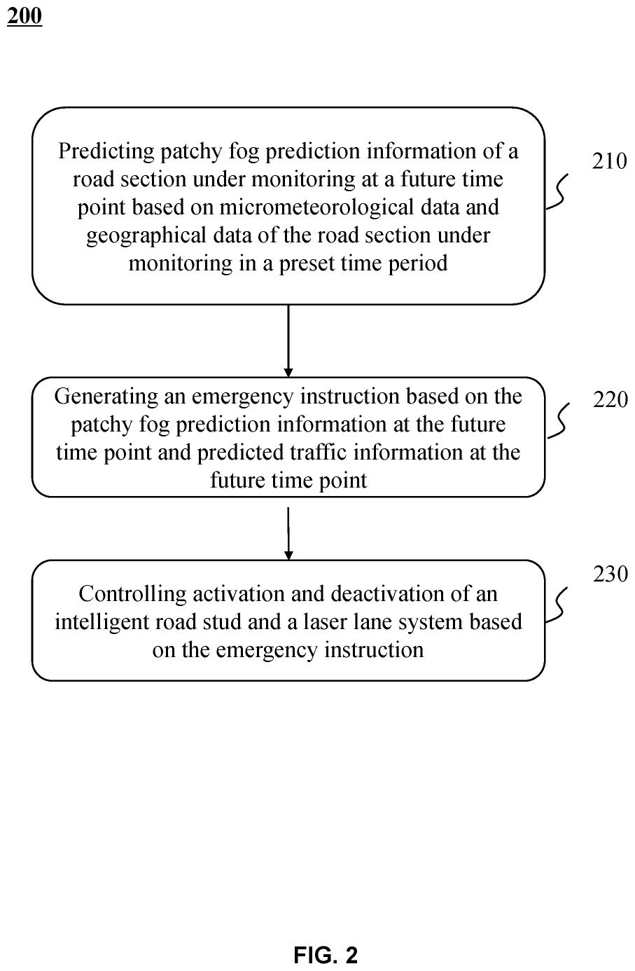

More descriptions regarding the above platforms may be found in FIG. 2 to FIG. 5 and related descriptions.

In the system 100 for emergency management and supervision of highway patchy fog based on an IoT large model, communication connections may be established between various functional platforms, an information operation closed loop may be formed among the functional platforms, and coordinated and regular operation may be achieved under the unified management of the emergency management and supervision platform, thereby achieving informatization and intelligence of urban highway patchy fog emergency management and supervision.

It should be noted that the above description of the system 100 for emergency management and supervision of highway patchy fog based on an IoT large model is only for convenience of description and cannot limit the present disclosure to the scope of the illustrated embodiments.

FIG. 2 is a flowchart illustrating an exemplary method for emergency management and supervision of highway patchy fog based on an IoT large model according to some embodiments of the present disclosure. Process 200 is an exemplary process of the method for emergency management and supervision of highway patchy fog based on an IoT large model. In some embodiments, the process 200 is performed by the emergency management and supervision platform 130. The process 200 includes 210-230.

In 210, patchy fog prediction information of the road section under monitoring at a future time point may be predicted by the emergency management and supervision platform based on micrometeorological data and geographical data of the road section under monitoring in a preset time period.

The preset time period refers to a historical time period with a preset duration. In some embodiments, the preset time period may be a time period prone to the patchy fog, e.g., 4:00 AM to 10:00 AM every day.

The road section under monitoring refers to a road section requiring emergency management and supervision due to the patchy fog.

The micrometeorological data refer to high-resolution meteorological observation data collected within a preset spatial range and a preset time scale. For example, visibility, temperature, humidity, wind speed and direction, atmospheric pressure, rainfall, or the like. The preset spatial range may be a spatial range with a specified point as a center and a distance, such as 1 m or 10 m, as a radius. The preset time scale may be 50 s or 1 h, etc.

The micrometeorological data may be collected by relevant sensors arranged at monitoring points on the road section under monitoring. For example, temperature and humidity may be obtained based on temperature sensors and humidity sensors arranged at the monitoring points. Visibility of the road section under monitoring may be obtained based on visibility sensors, or the like.

In some embodiments, the micrometeorological data of the road section under monitoring may also be obtained directly from meteorological bureau data.

The geographical data refers to high-precision geographic information system (GIS) data. For example, a digital elevation model (DEM), hydrological data, land use data, road network data, or the like. In some embodiments, the DEM may include altitude and slope data accurate to the meter level. The hydrological data may include vectorized maps of rivers, lakes, reservoirs, and swamps. The land use data may include different types of land and data thereof, such as vegetation, farmland, urban areas, and industrial areas. The road network data may include information such as road curvature, slope, ramps, bridges, and tunnels.

The geographical data may be obtained by consulting the land bureau and related websites.

In some embodiments, both the micrometeorological data and the geographical data carry precise timestamps and geographic coordinates.

The monitoring point refers to a point arranged at intervals along a driving direction of the road section under monitoring for monitoring and collecting the micrometeorological data and the geographical data. In some embodiments, the monitoring point may be preset in advance, e.g., deployed at a location prone to traffic congestion or a lane merge entrance on the road section under monitoring.

In some embodiments, the emergency management and supervision platform is further configured to: determine a patchy fog risk index of the road section under monitoring based on a historical fog occurrence frequency and a fog severity degree of the road section under monitoring; and determine a location of the monitoring point based on the patchy fog risk index.

In some embodiments, the emergency management and supervision platform may segment the road section under monitoring according to a fixed length (e.g., 500 meters) to form standardized road segment units.

The emergency management and supervision platform may collect historical data of each road segment unit. The historical data refers to historical data related to patchy fog risk of the standardized road segment unit over a past time period (e.g., the past 3-5 years). For example, accident records from traffic police departments (especially records marked with “weather reason—fog”), historical observation data, fog day reports from meteorological departments, and historical video recordings and event records from highway monitoring centers.

In some embodiments, the emergency management and supervision platform may obtain the historical data through meteorological bureaus and public records of traffic police, and align the historical data according to time. For example, the historical data may be aligned on a daily basis.

The patchy fog risk index refers to a quantitative comprehensive evaluation indicator of a probability of patchy fog occurrence and a potential hazard degree at a preset moment for the road segment unit. The patchy fog risk index of the road section under monitoring may be a sequence or a set composed of patchy fog risk indices of individual road segment units of the road section under monitoring.

The future time point refers to one or more time points in the future. For example, 30 minutes later. As another example, a plurality of consecutive time points at fixed time intervals in the future.

In some embodiments, the patchy fog risk index of the road segment unit is proportional to the historical fog occurrence frequency and the fog severity degree of the road segment unit.

In some embodiments, the historical fog occurrence frequency of the road segment unit may be calculated based on a ratio of a total count of days on which the road segment unit was recorded to have fog in the historical data to a total count of observation days corresponding to the historical data.

The fog severity degree refers to a comprehensive index for quantifying an intensity of fog formation, a duration, and an impact range of the fog. The fog severity degree of the road segment unit is directly proportional to average minimum visibility, average duration, and a count of fog-related accidents of the road segment unit.

The average duration refers to an average value of durations of all patchy fog events in the historical data over a past certain time period.

The count of fog-related accidents refers to a total count of all accidents that occurred during foggy weather in the historical data over a past certain time period.

In some embodiments, the fog severity degree may be obtained by a weighted calculation based on the average minimum visibility, the average duration, and the count of fog-related accidents. Weight coefficients respectively corresponding to the average minimum visibility, the average duration, and the count of fog-related accidents may be set by a technician based on prior experience. It should be noted that, before performing the weighted calculation on the average minimum visibility, the average duration, and the count of fog-related accidents, dimensionless processing, such as normalization processing, may be performed on all indicators of different dimensions.

In some embodiments, the patchy fog risk index of the road segment unit may be determined based on a weighted value of the historical fog occurrence frequency and the fog severity degree after respective normalization processing, wherein weights may be preset.

In some embodiments, the emergency management and supervision platform may rank the patchy fog risk indices of the road segment units in descending order, and determine the road segment units ranked in the top 10% or above a preset index threshold as the monitoring points. The preset index threshold is set by a technician based on prior experience.

In some embodiments of the present disclosure, determining monitoring point locations based on the patchy fog risk index can substantially enhance the accuracy of patchy fog warnings.

The patchy fog prediction information may include a patchy fog occurrence location, a patchy fog concentration, a patchy fog duration, or the like.

In some embodiments, the emergency management and supervision platform may predict the patchy fog prediction information of the road section under monitoring at the future time point based on the micrometeorological data and the geographical data of the road section under monitoring in the preset time period through various ways. For example, the emergency management and supervision platform may construct a vector based on the micrometeorological data and the geographical data, and determine the patchy fog prediction information based on retrieval in a vector database.

The emergency management and supervision platform may construct the vector database based on historical data. The vector database includes a plurality of historical vectors and a patchy fog label corresponding to each historical vector. The historical vector is constructed based on the micrometeorological data and the geographical data of a first historical time period of a historical monitoring road section. The patchy fog label is determined based on actual patchy fog information (e.g., a patchy fog occurrence location, a patchy fog concentration, a patchy fog duration, etc.) of the historical monitoring road section at a second historical time point. The second historical time point is a future time point of the first historical time period. The actual patchy fog information at the second historical time point may be determined based on historical monitoring.

The emergency management and supervision platform may construct a current feature vector based on the micrometeorological data and the geographical data of the road section under monitoring in the preset time period. Based on the current feature vector, a historical vector with a closest vector distance to the current feature vector is selected from the vector database, and the patchy fog label of the historical vector is used as the patchy fog prediction information of the road section under monitoring at the future time point.

In 220, an emergency instruction may be generated based on the patchy fog prediction information at the future time point and the predicted traffic information at the future time point.

The predicted traffic information refers to predicted traffic information of the road section under monitoring at the future time point.

In some embodiments, the predicted traffic information may include a traffic flow, an average vehicle speed, a lane occupancy rate, or the like, corresponding to the future time point.

In some embodiments, the predicted traffic information may be obtained from authoritative websites and data platforms. For example, the predicted traffic information may be obtained by querying a road network monitoring website platform of a traffic management department.

In some embodiments, the predicted traffic information may also be obtained in real time through collection devices installed on the roadside. For example, the predicted traffic information may be obtained in real time through collection devices such as roadside millimeter-wave radars, loops, and video detectors to acquire traffic information such as the traffic flow, the average vehicle speed, and the lane occupancy rate.

The emergency instruction refers to an instruction for implementing road management. For example, the emergency instruction may include instructions regarding the activation and deactivation of the intelligent road stud and the laser lane system at the future time point.

The emergency management and supervision platform may determine the emergency instruction based on the patchy fog prediction information at the future time point and the predicted traffic information at the future time point by querying a preset correspondence table. The preset correspondence table records a correspondence among the patchy fog prediction information, the predicted traffic information, and activation and deactivation states of the intelligent road stud and the laser lane system. The preset correspondence table may be preset based on historical experience.

In 230, activation and deactivation of the intelligent road stud and the laser lane system may be controlled based on the emergency instruction.

The intelligent road stud refers to an embedded road stud. The intelligent road stud may be powered by solar energy and may utilize wireless communication and sensing technology to flash at a specific frequency, emit a warning light of a predetermined brightness, or light up according to a specified pattern, thereby achieving dynamic lane management, traffic guidance, and safety warnings.

The laser lane system refers to a guidance system that dynamically forms a visual guidance mark on a road surface through laser projection technology. In some embodiments of the present disclosure, the guidance mark may be a pattern such as a green light band or a flowing arrow shape. A display style and a brightness of the guidance mark may be adjusted according to environmental conditions and the emergency instruction to enhance a visual guidance effect and improve driving safety.

In some embodiments of the present disclosure, collaborative patchy fog information prediction through the IoT large model and intelligent devices achieves precision, automation, and low cost in patchy fog emergency management, significantly improves road safety and traffic efficiency, and provides an innovative solution for urban transportation.

It should be noted that the above description of process 200 is merely for illustration and explanation, and does not limit the applicable scope of the present disclosure. For those skilled in the art, various modifications and changes to process 200 may be made under the guidance of the present disclosure. However, these modifications and changes are still within the scope of the present disclosure.

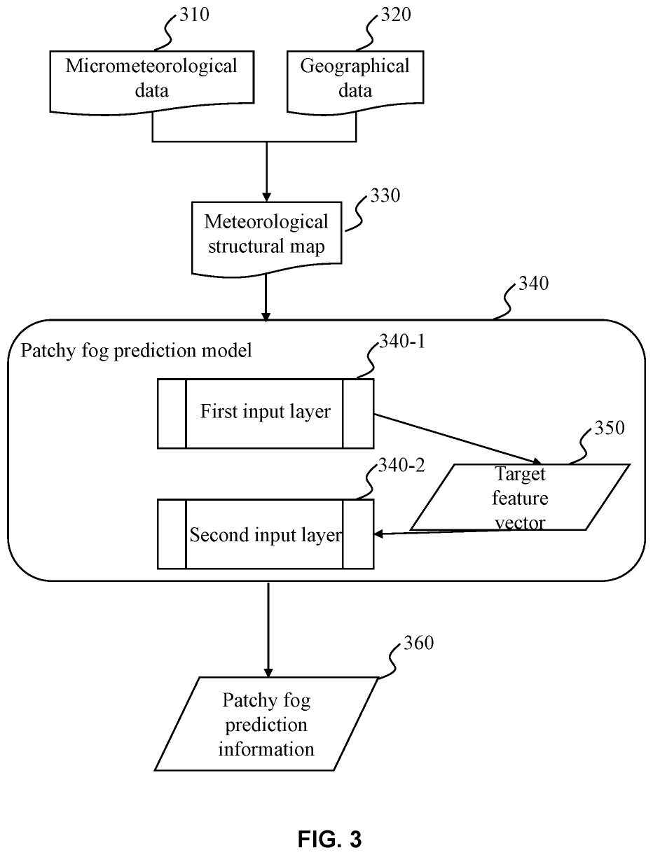

FIG. 3 is a schematic diagram illustrating an exemplary patchy fog prediction model according to some embodiments of the present disclosure.

In some embodiments, the emergency management and supervision platform is further configured to: construct a meteorological structural map 330 corresponding to a historical time point of the road section under monitoring based on the micrometeorological data 310 and the geographical data 320 of the preset time period; and predict the patchy fog prediction information 360 of the road section under monitoring at the future time point by a patchy fog prediction model 340 based on the meteorological structural map 330 corresponding to the historical time point, wherein the patchy fog prediction model is a machine learning model.

The meteorological structural map refers to a graph composed of nodes and edges that reflects a meteorological structure at a historical time node.

In some embodiments, the emergency management and supervision platform may construct the meteorological structural map corresponding to each historical time point based on historical data corresponding to representative historical time points in the preset time period. For example, the emergency management and supervision platform may select a group of representative historical time points at equal time intervals within a historical day as historical time points, and the meteorological structural map may be constructed for each historical time point.

In some embodiments, at each historical time point, the emergency management and supervision platform may treat each monitoring point in the road section under monitoring as a monitoring point node. Attributes of the monitoring point node may be represented based on an attribute vector. The attributes may include a node ID, longitude, latitude, altitude, visibility of the monitoring point at the historical time point, temperature, humidity, wind speed, wind direction, atmospheric pressure, or the like.

In some embodiments, the emergency management and supervision platform may treat important environmental elements such as rivers, lakes, and factories as environmental element nodes. An attribute vector of the environmental element node may include a node ID, a node type (e.g., river/lake/factory), area or length, a shortest distance to the road, or the like.

The node ID refers to a sequence number of the node among all nodes (including the monitoring point nodes and the environmental element nodes) at the corresponding historical time point. A process for obtaining the node sequence number is not limited. Merely by way of example, the emergency management and supervision platform may sequentially number nodes along the road section under monitoring according to a vehicle travel direction.

In some embodiments, the meteorological structural map includes a first edge, a second edge, and a third edge. Each edge has a corresponding weight as an attribute of the edge.

The emergency management and supervision platform may connect two monitoring point nodes whose spatial distance is less than a preset distance threshold (e.g., 2 kilometers) to form the first edge. A weight of the first edge may be inversely proportional to a distance between the two connected nodes. A shorter distance corresponds to a larger weight. The preset distance threshold may be set by a technician based on prior experience.

In some embodiments, the second edge refers to a dynamic directed edge connecting two nodes in the meteorological structural map according to a wind direction. The second edge may be generated based on wind direction data of the historical time point. For example, if wind blows from node A to node B, a directed edge from node A to node B is established as the second edge connecting node A and node B. A weight of the second edge may be proportional to a wind speed. A higher wind speed corresponds to a faster and stronger influence transmission from an upstream node to a downstream node.

In some embodiments, the emergency management and supervision platform may connect the environmental element node and the monitoring point node within an influence range of the environmental element node to form the third edge. The influence range of the environmental element node may be preset based on historical experience. For example, a lake node has five monitoring point nodes within a downwind range of 5 kilometers. At the historical time point, the emergency management and supervision platform may connect the lake node to the five monitoring point nodes within the downwind range of 5 kilometers to form five third edges. A weight of the third edge may be determined based on a distance and an environmental type.

For example, a technician may summarize an influence degree of distance and an influence degree of environmental type on the third edge based on prior experience (e.g., in an area adjacent to water, humidity has a strong influence degree on the weight), to obtain a preset distance-third edge weight correspondence table and a preset environmental type-third edge weight correspondence table. The technician may then obtain the weight of the third edge by consulting the preset distance-third edge weight correspondence table and the preset environmental type-third edge weight correspondence table.

The patchy fog prediction model refers to a model for predicting patchy fog prediction information at a future time point. The patchy fog prediction model is a machine learning model. For example, the patchy fog prediction model includes one or a combination of a deep neural network (DNN) model, a graph neural network (GNN) model, a long short-term memory (LSTM) network, or other custom models.

The patchy fog prediction model includes a first input layer 340-1 and a second input layer 340-2.

In some embodiments, the first input layer includes one or a combination of a GNN model or other custom models.

In some embodiments, the second input layer includes one or a combination of a LSTM model or other custom models.

An input of the first input layer includes at least one meteorological structural map corresponding to a historical time point. An output of the first input layer includes a target feature vector 350.

The target feature vector refers to a vector generated by an output of the first input layer for characterizing features of the meteorological structural map.

An input of the second input layer includes the target feature vector 350. An output of the second input layer includes the patchy fog prediction information of the road section under monitoring at the future time point. In some embodiments, the patchy fog prediction information may be represented in a form of a patchy fog prediction map. The patchy fog prediction map may be a geographic information system (GIS) map. The patchy fog prediction map precisely marks a patchy fog location, a patchy fog concentration, and patchy fog characteristic information of each road segment unit in the current road section under monitoring. The patchy fog characteristic information may include internal visibility classification (e.g., <50 m, 50-100 m, 100-200 m), fog top height, vertically integrated liquid water content, near-ground fog concentration, occurrence confidence, or the like.

In some embodiments, the first input layer and the second input layer may be obtained by jointly training an initial first input layer and an initial second input layer with first training samples having first labels. The first training sample may include the meteorological structural map corresponding to a first historical time point of a sample road section under monitoring. The first label may include an actual patchy fog map of the sample road section under monitoring corresponding to one or more time points after the first historical time point under the condition of the first training sample.

In some embodiments, the first training sample and the first label may be obtained based on historical data.

In some embodiments, the emergency management and supervision platform may input a plurality of first training samples with first labels into the initial first input layer to obtain sample target feature vectors output by the initial first input layer. The emergency management and supervision platform may input the sample target feature vectors into the initial second input layer, construct a loss function based on the labels and outputs of the initial second input layer, and iteratively update parameters of the initial first input layer and the initial second input layer based on the loss function through gradient descent or other ways. When a preset condition is satisfied, model training is completed, and a trained first input layer and a trained second input layer are obtained. The preset condition may be convergence of the loss function, a count of iterations reaching a threshold, or the like.

By combining the meteorological structural map with the machine learning model, patchy fog prediction achieves a leap from “experience-driven” to “data-driven,” improving accuracy and generalization capability of patchy fog prediction.

In some embodiments, an input of the patchy fog prediction model further includes an aerosol particle concentration at a current moment. The first training sample further includes a sample aerosol particle concentration corresponding to the sample road section under monitoring at the first historical time point.

The aerosol particle concentration refers to a total mass or a count concentration of solid or liquid fine particulate matter suspended in a unit volume of air.

A large number of microorganisms are suspended in the air and may form an aerosol microbial community. The microorganisms in the aerosol microbial community may serve as condensation nuclei, promoting water vapor condensation into fog droplets. Before patchy fog formation, a structure of the aerosol microbial community in the air may undergo characteristic changes. Therefore, the aerosol particle concentration is one of key indicators for measuring the degree of atmospheric pollution and influencing visibility (e.g., formation of fog, haze, or patchy fog).

The aerosol particle concentration may be collected by an environmental sampler disposed at a target point.

The environmental sampler refers to a dedicated device for collecting pollutants or specific components in environmental media such as air, water bodies, and soil. The environmental sampler may pump a large volume of air through a special filter membrane at regular intervals to capture aerosol particles in the air.

In some embodiments, the road segment unit with the patchy fog risk index higher than a preset index threshold may be determined as the target point. More descriptions regarding the patchy fog risk index may be found in FIG. 2 and related descriptions.

In some embodiments, the preset index threshold may be set by a technician based on prior experience.

By incorporating the aerosol particle concentration as an input to the patchy fog prediction model, accuracy of prediction results of the patchy fog prediction model can be improved.

In some embodiments, the monitoring point is further provided with a radar scanning array, and the micrometeorological data further includes fog field distribution data; the emergency management and supervision platform is further configured to: update the meteorological structural map corresponding to the historical time point based on the fog field distribution data corresponding to the historical time point to obtain an updated meteorological structural map; and predict the patchy fog prediction information of the road section under monitoring at the future time point by the patchy fog prediction model based on the updated meteorological structural map.

In some embodiments, the radar scanning array may include millimeter-wave radar and light detection and ranging (LiDAR).

In some embodiments, the emergency management and supervision platform may obtain raw point cloud data or reflectivity data scanned by the radar scanning array at a fixed frequency (e.g., per minute).

In some embodiments, the emergency management and supervision platform may perform preprocessing on the raw point cloud data or reflectivity data collected by the radar scanning array.

In some embodiments, the preprocessing includes background subtraction, noise filtering, vehicle filtering, or the like.

In some embodiments, the background subtraction refers to first establishing a static environmental point cloud library under clear and fog-free weather conditions, and then subtracting the static environmental point cloud library from currently collected point cloud data. The remaining point cloud is likely point cloud generated by aerosols such as fog, rain, or snow, or by moving vehicles.

In some embodiments, the noise filtering refers to removing isolated noise points using statistical processes (e.g., Statistical Outlier Removal).

In some embodiments, the vehicle filtering refers to identifying and removing the point cloud of vehicles by combining speed information from millimeter-wave radar or size/movement characteristics of point cloud clustering.

In some embodiments, the emergency management and supervision platform may further perform fog cluster identification and parameterization on the preprocessed raw point cloud data or reflectivity data to obtain the fog field distribution data. The fog cluster identification and parameterization includes: performing Density-Based Spatial Clustering of Applications with Noise (DBSCAN) or voxel-based clustering on the remaining aerosol point cloud to identify one or more fog clusters in three-dimensional space; and calculating physical parameters for each fog cluster. The physical parameters may include: a three-dimensional bounding box, centroid coordinates, volume, average point cloud density, shape descriptors, etc. The average point cloud density may serve as a proxy indicator for fog concentration. The fog field distribution data refers to data capable of characterizing a location distribution and physical parameters of each fog cluster.

In some embodiments, the emergency management and supervision platform may treat each fog cluster as a fog cluster node. For each fog cluster node, the emergency management and supervision platform may construct a fourth edge directed from the fog cluster node to the monitoring point node covered by the fog cluster node, thereby updating the meteorological structural map corresponding to the historical time point.

The monitoring point node covered by the fog cluster node refers to a monitoring point node within a fog formation range of the fog cluster node as shown in the fog field distribution data.

In some embodiments, an attribute vector of the fog cluster node includes physical parameters of the fog cluster node.

In some embodiments, the fourth edge may be directed or undirected. A weight of the fourth edge may be defined as a reciprocal of a distance from the monitoring point node corresponding to the fourth edge to a fog cluster center of the fog cluster node.

In some embodiments, the emergency management and supervision platform may further predict the patchy fog prediction information of the road section under monitoring at the future time point through the patchy fog prediction model based on the updated meteorological structural map corresponding to at least one historical time node.

In some embodiments of the present disclosure, by deploying the radar scanning array to obtain three-dimensional fog field distribution data, the internal structure of a fog cluster (e.g., density gradient) can be revealed, thereby significantly improving prediction resolution. The radar can operate under interference from strong wind or precipitation, compensating for failure risks of optical sensors (e.g., visibility meters).

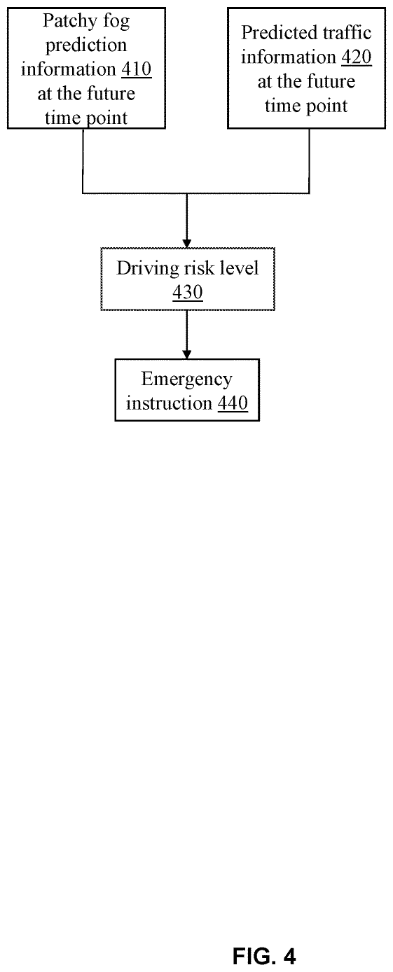

FIG. 4 is a schematic diagram illustrating an exemplary generation of an emergency instruction according to some embodiments of the present disclosure.

In some embodiments, the emergency management and supervision platform is further configured to: predict a driving risk level 430 based on the patchy fog prediction information 410 at the future time point and the predicted traffic information 420 at the future time point; and generate the emergency instruction 440 based on the driving risk level 440.

More descriptions regarding the patchy fog prediction information at the future time point may be found in FIG. 3 and related descriptions.

More descriptions regarding the predicted traffic information at the future time point may be found in FIG. 2 and related descriptions.

The driving risk level refers to a degree of risk of safety accidents occurring during vehicle travel on the road section under monitoring. In some embodiments, safety accidents may include sudden braking, emergency lane changes, traffic collisions, or the like.

In some embodiments, the driving risk level may be represented by a numerical value within a [0,1] interval, where a value closer to 1 indicates a higher driving risk level.

In some embodiments, the emergency management and supervision platform may predict the driving risk level based on the patchy fog prediction information at the future time point and the predicted traffic information at the future time point through various ways.

In some embodiments, the emergency management and supervision platform is further configured to: predict the driving risk level by a risk prediction model based on the patchy fog prediction information at the future time point, the predicted traffic information at the future time point, and animal acoustic data of the road section under monitoring during a current time period; wherein the risk prediction model is a machine learning model.

The animal acoustic data refers to sound data emitted by animals collected and recorded through acoustic means, used for analyzing behavior, state, or environmental responses of the animals.

In some embodiments, the animal acoustic data may be obtained based on acoustic monitors deployed in woods or grasslands along urban highways. The acoustic monitor refers to a device for collecting sound information in an environment.

The risk prediction model refers to a model for determining the driving risk level. In some embodiments, the risk prediction model may be a neural network (NN) model, a DNN model, other custom models, or a combination thereof.

In some embodiments, an input to the risk prediction model may be the patchy fog prediction information at the future time point, the predicted traffic information at the future time point, and the animal acoustic data of the road section under monitoring during the current time period. An output of the risk prediction model may be the driving risk level.

In some embodiments, the risk prediction model may be obtained by training an initial risk prediction model with a plurality of second training samples with second labels. The second training sample may include patchy fog information and traffic information corresponding to a fourth historical time point of a sample monitoring road section (also referred to as the sample road section under monitoring), and the animal acoustic data at a third historical time point. The second label may include an actual occurrence of safety accidents on the sample monitoring road section from the third historical time point to a fourth historical time point under the second training sample. The third historical time point precedes the fourth historical time point. In some embodiments of the present disclosure, a greater number or severity of safety accidents occurring within a time period from the third historical time point to the fourth historical time point corresponds to a value of the driving risk level for the sample monitoring road section closer to 1. For a sample monitoring road section where no safety accident occurred, the driving risk level is 0.

In some embodiments, the second training samples and the second labels may be obtained based on historical data.

In some embodiments, the emergency management and supervision platform may input a plurality of second training samples with the second labels into the initial risk prediction model, construct a loss function based on the second labels and results of the initial risk prediction model, and iteratively update parameters of the initial risk prediction model based on the loss function through gradient descent or other approaches. When a preset condition is satisfied, model training is completed, resulting in a trained risk prediction model. The preset condition may be a convergence of the loss function, a count of iterations reaching a threshold, or the like.

In some embodiments of the present disclosure, by introducing the animal acoustic data as a supplementary information source, combining the animal acoustic data with the patchy fog prediction information at the future time point and the predicted traffic information at the future time point, and constructing the risk prediction model using a machine learning model, more accurate prediction of the driving risk level can be achieved. The animal acoustic data can reflect subtle changes in the environment (e.g., atmospheric pressure, humidity, infrasound), and in some cases, the animal acoustic data can serve as precursor signals for extreme weather or geological anomalies, thereby further improving accuracy of the risk prediction model on top of meteorological and traffic data.

More descriptions regarding the emergency instruction may be found in step 220 and related descriptions.

In some embodiments, the emergency instruction may include a first-level emergency instruction, a second-level emergency instruction, a third-level emergency instruction, and a fourth-level emergency instruction.

In some embodiments, the emergency management and supervision platform may generate the emergency instruction based on the driving risk level using a first preset table. For example, the emergency management and supervision platform may generate the emergency instruction for the road section under monitoring by querying the first preset table based on the driving risk level of the road section under monitoring.

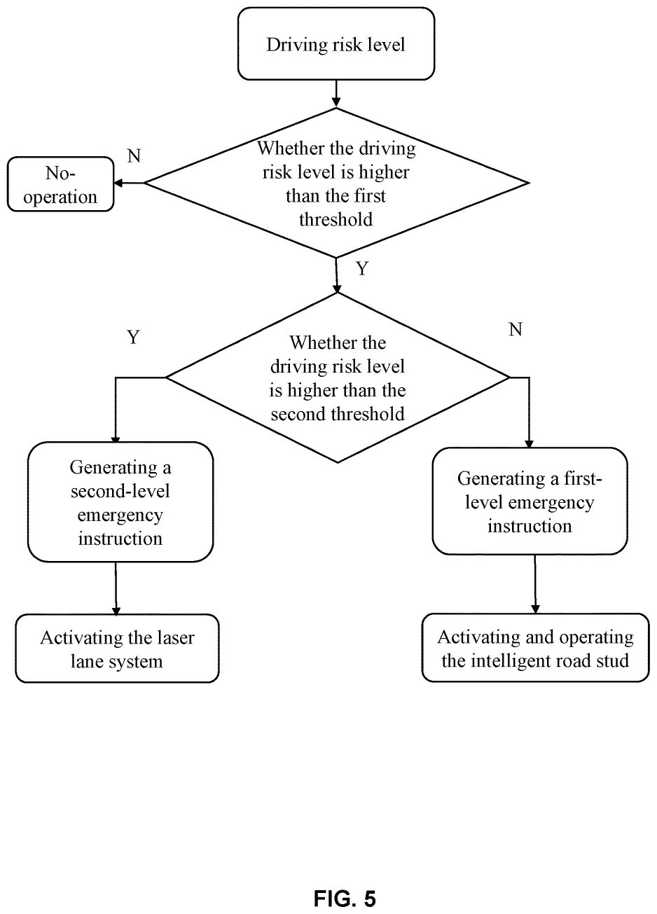

More detailed descriptions of how the emergency management and supervision platform generates the emergency instruction based on the driving risk level are provided in FIG. 5 and the related descriptions below.

In some embodiments of the present disclosure, by combining the patchy fog prediction information at the future time point with the predicted traffic information, low-visibility, high-risk traffic scenarios caused by patchy fog can be identified in advance, and the driving risk level can be predicted accordingly, thereby generating a matching emergency instruction. This approach can actively identify and respond to the patchy fog risks, significantly improve early warning capabilities and emergency response efficiency under such extreme weather conditions, effectively reduce the risk of traffic accidents (e.g., chain collisions), and enhance the safety and intelligence level of urban highway operation.

FIG. 5 is a schematic diagram illustrating an exemplary generation of a first-level emergency instruction and a second-level emergency instruction according to some embodiments of the present disclosure.

In some embodiments, the emergency management and supervision platform is further configured to: in response to determining that the driving risk level is higher than a first threshold and lower than a second threshold, generate a first-level emergency instruction, and activate and operate the intelligent road stud according to a first preset parameter based on the first-level emergency instruction; or in response to determining that the driving risk level is higher than the second threshold, generate a second-level emergency instruction, and activate the laser lane system based on the second-level emergency instruction.

More descriptions regarding the intelligent road stud and the laser lane system may be found in 230 and related descriptions.

The first threshold refers to a critical value of the driving risk level used to determine whether to generate and execute the first-level emergency instruction.

The second threshold refers to a critical value of the driving risk level used to determine whether to generate and execute the second-level emergency instruction.

In some embodiments, the first threshold and the second threshold may be set by technicians based on experience. The second threshold is greater than the first threshold.

In some embodiments, the emergency management and supervision platform is further configured to: dynamically update the first threshold and the second threshold based on a preset base threshold and a patchy fog correction coefficient, wherein the patchy fog correction coefficient is related to a patchy fog risk index of a road segment unit.

The preset base threshold refers to a preset reference value used for initially setting grading standards for the driving risk level. The preset base threshold may serve as a benchmark for dynamically adjusting the first threshold and the second threshold. In some embodiments, the preset base threshold includes a preset base threshold for the first threshold and a preset base threshold for the second threshold, which can be set by technical personnel based on experience.

In some embodiments, the preset base threshold for the first threshold is less than the preset base threshold for the second threshold.

The patchy fog correction coefficient refers to an adjustment parameter used for dynamically adjusting thresholds related to generating the emergency instruction according to changes in the patchy fog risk index. More descriptions regarding the patchy fog risk index may be found in FIG. 2 and related descriptions.

In some embodiments, the patchy fog correction coefficient is negatively correlated with the patchy fog risk index of the road segment unit.

In some embodiments, the patchy fog correction coefficient may be determined based on a second preset table. For example, the emergency management and supervision platform may determine a current patchy fog correction coefficient for each road segment unit by querying the second preset table based on a current patchy fog risk index of each road segment unit of the road section under monitoring.

In some embodiments, the patchy fog correction coefficient for the road section under monitoring may be a statistical value of the patchy fog correction coefficients of the road segment units. The statistical value may include an average value, a weighted sum, or the like.

In some embodiments, the emergency management and supervision platform may dynamically update the first threshold and the second threshold based on the preset base threshold and the patchy fog correction coefficient in various ways.

For example, a dynamic update process for the first threshold and the second threshold is shown by the following formulas.

The first threshold=the preset base threshold for the first threshold/the patchy fog correction coefficient.

The second threshold=the preset base threshold for the second threshold/the patchy fog correction coefficient.

In some embodiments of the present disclosure, the introduction of a dynamic threshold adjustment mechanism based on the preset base threshold and the patchy fog correction coefficient enables the system to automatically calibrate its sensitivity according to weather hazard levels. This facilitates earlier and more timely warnings during high-risk scenarios such as foggy conditions while preventing overreactions under normal weather conditions. Consequently, it achieves precise, efficient, and adaptive management of road safety risks.

The first-level emergency instruction refers to the emergency instruction generated when the driving risk level is higher than the first threshold and lower than the second threshold. For example, the first-level emergency instruction may include activating a constant-on mode of the intelligent road stud, activating a red breathing light mode of the intelligent road stud, linking with an in-vehicle system to issue a voice warning, or the like.

The first preset parameter refers to a set of parameters used to control an operating state of the intelligent road stud when the first-level emergency instruction is triggered. In some embodiments, the first preset parameter may include brightness of the intelligent road stud, a flashing frequency of the intelligent road stud, a duration of the intelligent road stud, or the like.

In some embodiments, the first preset parameter may be set based on technician experience.

In some embodiments, in response to determining that the driving risk level is higher than the first threshold and lower than the second threshold, a processor generates the first-level emergency instruction and, based on the first-level emergency instruction, activates and operates the intelligent road stud according to the first preset parameter.

In some embodiments, operating the intelligent road stud according to the first preset parameter may include controlling the intelligent road stud to flash at a specific frequency, emit a warning light of a predetermined brightness, or light up in a specified pattern.

The second-level emergency instruction refers to the emergency instruction generated when the driving risk level is higher than the second threshold. For example, the second-level emergency instruction may include activating the laser lane system, activating broadcast warnings inside a tunnel, activating auxiliary fog lighting, or the like.

In some embodiments, the emergency management and supervision platform is further configured to: determine a deployment location of an acoustic wave generating array based on a patchy fog risk index of a road segment unit; and in response to determining that the driving risk level is higher than the second threshold, generate a third-level emergency instruction, and control the acoustic wave generating array based on the third-level emergency instruction to emit an acoustic wave of a preset frequency in a target direction to perform a fog clearing operation.

The acoustic wave generating array refers to a device composed of a plurality of sound generators for generating directional acoustic waves or specific acoustic effects. In some embodiments, the acoustic wave generating array may be an infrasound generator array or a strong acoustic wave generator array. For example, the acoustic wave generating array may include a directional acoustic wave device, a GFZ Potsdam infrasound monitoring array, a TDK ultrasonic defogging module, or the like.

The deployment location refers to a spatial position or area where a device is installed or deployed.

In some embodiments, when the patchy fog risk index of a road segment unit is higher than a preset third threshold, the acoustic wave generating array may be deployed in the road segment unit. More descriptions regarding the patchy fog risk index may be found in FIG. 2 and related descriptions.

In some embodiments, the preset third threshold may be determined based on technician's experience.

The third-level emergency instruction refers to an instruction for controlling the acoustic wave generating array. For example, the third-level emergency instruction may include activating the acoustic wave generating array, deactivating the acoustic wave generating array, or the like.

The target direction refers to a direction in which a predicted patchy fog location in the patchy fog prediction information at the future time point is located.

The fog clearing operation refers to a process of intervening in the patchy fog through external physical or chemical means to achieve dilution, dispersion, or elimination of the patchy fog. For example, the fog clearing operation may include using the acoustic waves to disperse fog, blowing away a fog layer with a wind device, or spraying a desiccant to adsorb moisture in the air, or the like.

In some embodiments, the acoustic wave generating array may generate the acoustic waves in a target direction at a preset frequency to perform the fog clearing operation. The preset frequency may be set based on experience of a technician.

In some embodiments of the present disclosure, by determining the deployment location of the acoustic wave generating array based on the patchy fog risk index, and generating the third-level emergency instruction to control the acoustic wave generating array in response to the driving risk level being higher than the second threshold, directional clearance of a patchy fog area can be achieved. The acoustic waves are emitted at the preset frequency toward the target direction, effectively acting on the patchy fog area, improving visibility, and enhancing traffic safety and emergency response capability of a road section.

In some embodiments, the emergency management and supervision platform is further configured to: determine a deployment location of a vortex generator based on a patchy fog risk index of a road segment unit; and in response to determining that the driving risk level is higher than the second threshold, generate a fourth-level emergency instruction, and control the vortex generator based on the fourth-level emergency instruction to perform a fog clearing operation at a preset power in a target direction.

In some embodiments, when the patchy fog risk index of a road segment unit is higher than the preset third threshold, the vortex generator may be deployed at the road segment unit. More descriptions regarding the patchy fog risk index may be found in FIG. 2 and related descriptions.

The fourth-level emergency instruction refers to an instruction for controlling a vortex generator. For example, the fourth-level emergency instruction may include starting the vortex generator, activating a pulse clearing mode, and turning off the vortex generator.

In some embodiments, the emergency management and supervision platform is configured to, in response to determining that the driving risk level is higher than the second threshold, generate the fourth-level emergency instruction, and control the vortex generator based on the fourth-level emergency instruction to perform the fog clearing operation at the preset power in the target direction. The preset power may be obtained based on experience of a technician.

In some embodiments of the present disclosure, by determining the deployment location of the vortex generator based on the patchy fog risk index, and generating the fourth-level emergency instruction in response to the driving risk level being higher than the second threshold, the emergency management and supervision platform controls the vortex generator to perform the fog clearing operation at the preset power and toward the target direction. This helps to quickly intervene in a high-risk patchy fog road section, enhances visibility, and improves road traffic safety and proactivity of emergency management under adverse weather conditions.

Basic concepts have been described above. Obviously, for a person skilled in the art, the above detailed disclosure is merely an example and does not constitute a limitation on the present disclosure. Although not explicitly stated herein, a person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe embodiments of the present disclosure. For example, terms such as “an embodiment,” “one embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different locations in the present disclosure does not necessarily refer to the same embodiment. Furthermore, certain features, structures, or characteristics in one or more embodiments of the present disclosure may be appropriately combined.

Furthermore, unless explicitly stated in the claims, the order of processing elements and sequences, the use of numbers and letters, or the use of other names described in the present disclosure is not intended to limit the order of processes and methods of the present disclosure. Although the foregoing disclosure discusses some inventive embodiments currently considered useful through various examples, it should be understood that such details are for illustrative purposes only. The appended claims are not limited to the disclosed embodiments. On the contrary, the claims are intended to cover all modifications and equivalent combinations that conform to the essence and scope of the embodiments of the present disclosure. For example, although the implementation of various components described above may be embodied in a hardware device, it may also be implemented as a software only solution, e.g., an installation on an existing server or mobile device.

Similarly, it should be noted that, in order to simplify the description of the present disclosure and thereby facilitate an understanding of one or more embodiments of the invention, various features are sometimes grouped into a single embodiment, figure, or description thereof in the foregoing description of the embodiments of the present disclosure. However, this method of disclosure does not imply that the object of the present disclosure requires more features than those recited in the claims. Rather, claimed subject matter may lie in less than all features of a single foregoing disclosed embodiment.

In some embodiments of the present disclosure, numbers describing quantities of ingredients or properties are used. It should be understood that such numbers used in describing the embodiments are, in some examples, modified by the terms “about,” “approximately,” or “substantially.” Unless otherwise stated, “about,” “approximately,” or “substantially” indicates that the stated number allows a variation of ±20%. Accordingly, in some embodiments of the present disclosure, the numerical parameters set forth in the present disclosure and claims are approximations that may vary depending upon the desired properties of the individual embodiments. In some embodiments of the present disclosure, the numerical parameters should be considered in light of the number of reported significant digits and by applying ordinary rounding techniques. Although the numerical ranges and parameters setting forth the broad scope of some embodiments of the present disclosure are approximations, the numerical values set forth in the specific examples are reported as precisely as possible within the feasible range.

Each patent, patent application, patent application publication, and other material, such as articles, books, specifications, publications, documents, etc., cited herein is hereby incorporated by reference in its entirety. This incorporation excludes any application history documents that are inconsistent with or conflict with the content of the present disclosure, and also excludes any documents that limit the broadest scope of the claims of the present disclosure (whether currently or subsequently appended to the present disclosure). It should be noted that, if the description, definition, and/or use of terms in any incorporated material is inconsistent or conflicts with the description, definition, and/or use of terms in the present disclosure, the description, definition, and/or use of terms in the present disclosure shall prevail.

Finally, it should be understood that the embodiments described herein are merely illustrative of the principles of the embodiments of the present disclosure. Other variations may also fall within the scope of the present disclosure. Accordingly, by way of example and not limitation, alternative configurations of the embodiments of the present disclosure may be considered consistent with the teachings of the present disclosure. Accordingly, the embodiments of the present disclosure are not limited to those explicitly described and illustrated herein.

What is claimed is:

1. A system for emergency management and supervision of highway patchy fog based on an Internet of Things (IoT) large model, comprising: an emergency management and supervision platform, wherein the emergency management and supervision platform is configured to:
predict patchy fog prediction information of a road section under monitoring at a future time point based on micrometeorological data and geographical data of the road section under monitoring in a preset time period, wherein the micrometeorological data is collected by a monitoring point arranged on the road section under monitoring;
generate an emergency instruction based on the patchy fog prediction information at the future time point and predicted traffic information at the future time point; and
control activation and deactivation of an intelligent road stud and a laser lane system based on the emergency instruction.

2. The system according to claim 1, wherein the emergency management and supervision platform is further configured to:
determine a patchy fog risk index of the road section under monitoring based on a historical fog occurrence frequency and a fog severity degree of the road section under monitoring; and
determine a location of the monitoring point based on the patchy fog risk index.

3. The system according to claim 1, wherein the emergency management and supervision platform is further configured to:
construct a meteorological structural map corresponding to a historical time point of the road section under monitoring based on the micrometeorological data and the geographical data of the preset time period; and
predict the patchy fog prediction information of the road section under monitoring at the future time point by a patchy fog prediction model based on the meteorological structural map corresponding to the historical time point, wherein the patchy fog prediction model is a machine learning model.

4. The system according to claim 3, wherein an input of the patchy fog prediction model further includes an aerosol particle concentration at a current moment, the aerosol particle concentration is collected by an environmental sampler at a target point, and a patchy fog risk index of the target point is higher than a preset index threshold.

5. The system according to claim 3, wherein the monitoring point is further provided with a radar scanning array, and the micrometeorological data further includes fog field distribution data;
the emergency management and supervision platform is further configured to:
update the meteorological structural map corresponding to the historical time point based on the fog field distribution data corresponding to the historical time point to obtain an updated meteorological structural map; and
predict the patchy fog prediction information of the road section under monitoring at the future time point by the patchy fog prediction model based on the updated meteorological structural map.

6. The system according to claim 1, wherein the emergency management and supervision platform is further configured to:
predict a driving risk level based on the patchy fog prediction information at the future time point and the predicted traffic information at the future time point; and
generate the emergency instruction based on the driving risk level.

7. The system according to claim 6, wherein the emergency management and supervision platform is further configured to:
predict the driving risk level by a risk prediction model based on the patchy fog prediction information at the future time point, the predicted traffic information at the future time point, and animal acoustic data of the road section under monitoring during a current time period; wherein the risk prediction model is a machine learning model.

8. The system according to claim 6, wherein the emergency management and supervision platform is further configured to:
in response to determining that the driving risk level is higher than a first threshold and lower than a second threshold, generate a first-level emergency instruction, and activate and operate the intelligent road stud according to a first preset parameter based on the first-level emergency instruction; or
in response to determining that the driving risk level is higher than the second threshold, generate a second-level emergency instruction, and activate the laser lane system based on the second-level emergency instruction.

9. The system according to claim 8, wherein the emergency management and supervision platform is further configured to:
dynamically update the first threshold and the second threshold based on a preset base threshold and a patchy fog correction coefficient, wherein the patchy fog correction coefficient is related to a patchy fog risk index of a road segment unit.

10. The system according to claim 8, wherein the emergency management and supervision platform is further configured to:
determine a deployment location of an acoustic wave generating array based on a patchy fog risk index of a road segment unit; and
in response to determining that the driving risk level is higher than the second threshold, generate a third-level emergency instruction, and control the acoustic wave generating array based on the third-level emergency instruction to emit an acoustic wave of a preset frequency in a target direction to perform a fog clearing operation.

11. The system according to claim 8, wherein the emergency management and supervision platform is further configured to:
determine a deployment location of a vortex generator based on a patchy fog risk index of a road segment unit; and
in response to determining that the driving risk level is higher than the second threshold, generate a fourth-level emergency instruction, and control the vortex generator based on the fourth-level emergency instruction to perform a fog clearing operation at a preset power in a target direction.

12. A method for emergency management and supervision of highway patchy fog based on an Internet of Things (IoT) large model, the method being performed by an emergency management and supervision platform for emergency management and supervision of highway patchy fog based on the IoT large model, the method comprising:
predicting patchy fog prediction information of a road section under monitoring at a future time point based on micrometeorological data and geographical data of the road section under monitoring in a preset time period, wherein the micrometeorological data is collected by a monitoring point arranged on the road section under monitoring;
generating an emergency instruction based on the patchy fog prediction information at the future time point and predicted traffic information at the future time point; and
controlling activation and deactivation of an intelligent road stud and a laser lane system based on the emergency instruction.

13. The method according to claim 12, wherein the method further comprises:
determining a patchy fog risk index of the road section under monitoring based on a historical fog occurrence frequency and a fog severity degree of the road section under monitoring; and
determining a location of the monitoring point based on the patchy fog risk index.

14. The method according to claim 12, wherein the predicting patchy fog prediction information of the road section under monitoring at the future time point based on micrometeorological data and geographical data of the road section under monitoring in the preset time period includes:
constructing a meteorological structural map corresponding to a historical time point of the road section under monitoring based on the micrometeorological data and the geographical data of the preset time period; and
predicting the patchy fog prediction information of the road section under monitoring at the future time point by a patchy fog prediction model based on the meteorological structural map corresponding to the historical time point, wherein the patchy fog prediction model is a machine learning model.

15. The method according to claim 14, wherein the monitoring point is further provided with a radar scanning array, and the micrometeorological data further includes fog field distribution data;
the method further comprises:
updating the meteorological structural map corresponding to the historical time point based on the fog field distribution data corresponding to the historical time point to obtain an updated meteorological structural map; and
predicting the patchy fog prediction information of the road section under monitoring at the future time point by the patchy fog prediction model based on the updated meteorological structural map.

16. The method according to claim 12, wherein the generating an emergency instruction based on the patchy fog prediction information at the future time point and the predicted traffic information at the future time point includes:
predicting a driving risk level based on the patchy fog prediction information at the future time point and the predicted traffic information at the future time point; and
generating the emergency instruction based on the driving risk level.

17. The method according to claim 16, wherein the predicting a driving risk level based on the patchy fog prediction information at the future time point and the predicted traffic information at the future time point includes:
predicting the driving risk level by a risk prediction model based on the patchy fog prediction information at the future time point, the predicted traffic information at the future time point, and animal acoustic data of the road section under monitoring during a current time period; wherein the risk prediction model is a machine learning model.

18. The method according to claim 16, wherein the generating the emergency instruction based on the driving risk level includes:
in response to determining that the driving risk level is higher than a first threshold and lower than a second threshold, generating a first-level emergency instruction, and activating and operating the intelligent road stud according to a first preset parameter based on the first-level emergency instruction; or
in response to determining that the driving risk level is higher than the second threshold, generating a second-level emergency instruction, and activating the laser lane system based on the second-level emergency instruction.

19. The method according to claim 18, wherein the method further comprises:
dynamically updating the first threshold and the second threshold based on a preset base threshold and a patchy fog correction coefficient, wherein the patchy fog correction coefficient is related to a patchy fog risk index of a road segment unit.

20. A non-transitory computer-readable storage medium, wherein the storage medium stores computer instructions, and when a computer reads the computer instructions in the storage medium, the computer executes the method according to claim 12.
